(19) United States
(12) Patent Application Publication
(10) Pub. No.: US 2014/0325535 A1
(43) Pub. Date: Oct. 30, 2014

(54) METHOD OF SWITCHING DESKTOP SUBJECTS OF MOBILE TERMINAL AND ITS SWITCHING APPARATUS

(71) Applicant: TENCENT TECHNOLOGY (SHENZHEN) COMPANY LIMITED, Shenzhen (CN)

(72) Inventor: Chaozhong LI, Shenzhen (CN)

(73) Assignee: TENCENT TECHNOLOGY (SHENZHEN) COMPANY LIMITED, Shenzhen (CN)

(21) Appl. No.: 14/263,801

(22) Filed: Apr. 28, 2014

Related U.S. Application Data
(63) Continuation of application No. PCT/CN2013/089273, filed on Dec. 12, 2013.

(30) Foreign Application Priority Data
Apr. 24, 2013 (CN) 201310145116.X

(51) Int. Cl. G06F 9/54

(52) U.S. Cl. CPC G06F 9/54
USPC 719/329

(57) ABSTRACT

The present disclosure is applied to information technology field, provides a method and an apparatus of switching desktop subjects of a mobile terminal, the method comprises the following steps scanning the desktop subject list in the mobile terminal; determining the target desktop subject to be switched to from the desktop subject list; executing the desktop subject program corresponding to the target desktop subject to control the interface arrangement and the interface operating manner of the mobile terminal desktop through the desktop subject program. By controlling the interface arrangement and the interface operating manner of the mobile terminal desktop through the executed desktop subject program, the diversification and better interaction of the switching form of the desktop subject can be experienced.

### CROSS-REFERENCE TO RELATED APPLICATIONS

This application is a continuation application of PCT Patent Application No. PCT/CN2013/089273, entitled “Method of Switching Desktop Subjects of Mobile Terminal and Its Switching Apparatus,” filed on Dec. 12, 2013, which claims priority benefit of Chinese Patent Application No. 201310145116.X, entitled “Method of Switching Desktop Subjects of Mobile Terminal and Its Switching Apparatus,” filed on Apr. 24, 2013, the disclosures of which are herein incorporated by reference in their entireties.

### TECHNICAL FIELD

The present disclosure relates to information technology field, more particularly, to a method of switching desktop subjects of a mobile terminal and its switching apparatus.

### BACKGROUND

With the growing popularity of smart operating systems in mobile terminals, there are more and more application programs executing in mobile terminals. For example, desktop application programs may be run in mobile terminals. These are used to manage and display various application programs that have been installed in the mobile terminals, as well as application programs of widgets, which only can be displayed on the mobile terminal desktops.

Prior desktop application programs provide multiple functions, so that the user can operate the mobile terminal conveniently and quickly, thus enhancing the user's experience. For example, the prior desktop application programs provide multiple desktop subjects, and each desktop subject provides a different display effect of an interface for the user.

In order to make the user use various desktop subjects provided by the desktop application program, the prior art provides a desktop subject switching method, the process of which is simply described as follows when the desktop subject switching instructions are received, the picture or the color of the application program icon displayed on the mobile terminal desktop is replaced with the picture or the color specified by the desktop subject switching instruction, so that the process of switching the mobile terminal desktop subject can be carried out.

### SUMMARY OF THE DISCLOSURE

The above manner of switching subjects in the prior art only substitutes the picture or the color of the application program icon displayed on the mobile terminal desktop, whereby the form of subject switching is unitary, and the interaction is poor. Therefore, the embodiments of the present disclosure provide a new method of switching desktop subjects of the mobile terminal and its switching apparatus.

According to a first aspect of the present disclosure, there is provided a method of switching desktop subjects of a mobile terminal, comprising scanning, by a list scanning unit (also referred as “module”) using a processor, the desktop subject list in the mobile terminal; determining, by a target subject determining unit using a processor, the target desktop subject to be switched to from the desktop subject list; executing, by a subject switching unit using a processor, the desktop subject program corresponding to the target desktop subject in the mobile terminal to control the interface arrangement and the interface operating manner of the mobile terminal desktop through the desktop subject program.

According to a second aspect of the present disclosure, there is further provided an apparatus for switching desktop subjects of a mobile terminal, comprising a list scanning unit using a processor and configured to scan the desktop subject list in the mobile terminal; a target subject determining unit using a processor and configured to determine the target desktop subject to be switched to from the desktop subject list; a subject switching unit using a processor and configured to execute the desktop subject program corresponding to the target desktop subject in the mobile terminal, and to control the interface arrangement and the interface operating manner of the mobile terminal desktop through the desktop subject program.

According to a third aspect of the present disclosure, there is provided a mobile terminal comprising an apparatus for switching desktop subjects of a mobile terminal provided according to the second aspect of the present disclosure.

According to a fourth aspect of the present disclosure, there is provided a non-transitory computer readable medium storing program instructions; when the program instructions are executed on the computer, they prompt the computer to execute the respective steps of the method of switching desktop subjects of a mobile terminal provided according to the first aspect of the present disclosure.

In the embodiments of the present disclosure, it is by determining the target desktop subject to be switched to from the desktop subject list in the mobile terminal by scanning it; executing the desktop subject program corresponding to the target desktop subject in the mobile terminal; controlling the interface arrangement and the interface operating manner of the mobile terminal desktop through the executed desktop subject program, that the diversification and better interaction of the switching form of the desktop subjects can be experienced.

### BRIEF DESCRIPTION OF THE DRAWINGS

In order to illustrate the technical solution of the embodiments of the present disclosure more clearly, the accompanying drawings used in the description of the embodiments or prior art will be introduced briefly, and are just some embodiments of the present disclosure. Furthermore, for those skilled in the art, other accompanying drawings may be obtained without creative efforts according to these accompanying drawings.

FIG. 1 is a schematic flow diagram showing a method of switching desktop subjects of a mobile terminal according to an embodiment of the present disclosure;

FIG. 2 is a flow diagram showing a method of switching desktop subjects based on the desktop application program according to the embodiment of the present disclosure;

FIG. 3 is a block diagram showing an apparatus for switching desktop subjects of a mobile terminal according to the embodiment of the present disclosure;

FIG. 4 is a block diagram showing an apparatus for switching desktop subjects of a mobile terminal according to another embodiment of the present disclosure; and

FIG. 5 is a block diagram showing a mobile terminal of the respective embodiments of the present disclosure.

### DESCRIPTION OF THE EMBODIMENTS

To make the object, the technical solution and advantages of the present disclosure more apparent, a more detailed illustration of the present disclosure will be given in conjunction with the embodiments and the accompanying drawings. It should be understood that the embodiments shown herein are only used to explain the present disclosure, not to limit the scope of the present disclosure.

In the embodiments of the present disclosure, it is by determining the target desktop subject to be switched to from the desktop subject list in the mobile terminal by scanning it; executing the desktop subject program corresponding to the target desktop subject in the mobile terminal; controlling the interface arrangement and the interface operating manner of the mobile terminal desktop through the executed desktop subject program, that the diversification and better interaction of the switching form of the desktop subjects can be experienced.

Next, the technical solution of present disclosure will be illustrated through the embodiments.

### Embodiment 1

FIG. 1 is a schematic flow diagram showing a method of switching desktop subjects of a mobile terminal according to an embodiment of the present disclosure. The switching method includes the following steps.

In step S101, the desktop subject list in the mobile terminal is scanned.

In this embodiment, the desktop subject program having been downloaded and installed in the mobile terminal is scanned, and desktop subjects corresponding to the scanned desktop subject programs are assembled as a desktop subject list.

Specifically, in order to make a mobile terminal switch multiple desktop subjects to provide more diversified desktop demonstration effects for the user, the desktop subject program may be built in the mobile terminal in advance, or the desktop subject program is downloaded dynamically from a network or other channels by the mobile terminal, and the downloaded desktop subject program is installed in the mobile terminal locally. When the desktop subjects need to be switched, the mobile terminal scans the desktop subject programs that have been downloaded and installed locally therein and the desktop subject programs built in the mobile terminal, and the desktop subjects corresponding to the scanned desktop subject programs are assembled as a desktop subject list.

In another embodiment of the present disclosure, the desktop subject list can also be downloaded from a network. The process to download the desktop subject list from the network may be the mobile terminal sends a download request to the desktop subject server in a network to download a desktop subject list from the desktop subject server in the network. The desktop subject server may push the desktop subject list to the mobile terminal.

The desktop subject program is an application program used to control and manage the interface arrangement and the interface operating manner of the mobile terminal desktop. The interface arrangement is a display arrangement of interface elements to be displayed on the mobile terminal desktop. The interface operating manner is a response process to the operating action of the user on the mobile terminal desktop.

The interface arrangement includes but is not limited to the page arrangement of a mobile terminal desktop and the interface element arrangement on that page. The page arrangement of a mobile terminal desktop includes but is not limited to the number of pages obtained by dividing the mobile terminal desktop, interface elements displayed by each page, a background picture of each page, and the like. The interface element arrangement on the same page includes but is not limited to the position, picture, and color of the interface elements, and the like. For example, when the interface element is an application program icon, the interface element arrangement includes the picture of the application program icon, the position of the application program icon, and the like.

The interface operating manners will be illustrated by examples, but they are not limited to those examples. For example, the interface operating manners are the response manners to a slip gesture, a long time press gesture, a slip gesture after a long time press, and the like made by the user on the mobile terminal desktop. For example, when the user presses an application program icon on the mobile terminal desktop, in the process of executing the application program corresponding to the application program icon, an animation and the like is played.

In this embodiment, the interface arrangement and interface operating manner defined in each desktop subject program represent a desktop subject, because different desktop subject programs provide different interface arrangements and different interface operating manners, the desktop demonstration effects presented by the desktop subjects corresponding to different desktop subject programs may be totally different.

In this embodiment, after desktop subject list display instructions are received, the desktop subject list in the mobile terminal is scanned. The process of entering the desktop subject list display instructions can be predefined arbitrarily.

In step S102, the target desktop subject to be switched to from the desktop subject list is determined.

The process to determine the target desktop subject to be switched to from the desktop subject list includes but is not limited to through the upward moving button and the downward moving button of the mobile terminal, move upward or downward among the respective desktop subjects in the desktop subject list, and select a desktop subject in the desktop subject list, and determine the selected desktop subject as the target desktop subject to be switched to. Alternatively, select a desktop subject in the desktop subject list through the touch screen of the mobile terminal, and determine the selected desktop subject as the target desktop subject to be switched to.

In step S103, the desktop subject program corresponding to the target desktop subject in the mobile terminal is executed, and the interface arrangement and interface operating manner of the mobile terminal desktop through the desktop subject program is controlled.

Specifically, after executing the desktop subject program corresponding to the target desktop subject in the mobile terminal, the desktop subject program rearranges the mobile terminal desktops according to its set interface arrangement, and responds to the operating actions of the user on the mobile terminal desktop according to the interface operating manner set by the desktop subject program, so that both the interface arrangement and the interface operating manner of the mobile terminal desktop are switched to the interface arrangement and the interface operating manner set in the desktop subject program.

The “executing the desktop subject program corresponding to the target desktop subject in the mobile terminal” may be embodied as follows.

The desktop subject program corresponding to the target desktop subject in the mobile terminal is executed through the “intent” process. The “intent” is a “medium” or “messenger” for communicating among different components, and the “intent” refers to an abstracted description of executing a certain operation, which is used to describe the action of one operation, the data referred to by the action, and additional data. Its specific process is as follows:

A1. The “intent” used to execute the desktop subject program corresponding to the target desktop subject is constructed.

The “intent” is used to inform the operating system of the mobile terminal that the target desktop subject is to be switched.

A2. The desktop subject program corresponding to the target desktop subject is executed by the operating system of the mobile terminal according to the “intent”.

In this embodiment, the operating system of the mobile terminal calls the desktop subject program corresponding to the target desktop subject in the mobile terminal according to the description in the “intent” to execute the desktop subject program corresponding to the target desktop subject.

In another embodiment of the present disclosure, “executing the desktop subject program corresponding to the target desktop subject in the mobile terminal” may be embodied as follows:

B1. Obtaining the desktop subject program package corresponding to the target desktop subject.

In this embodiment, it may first scan the mobile terminal to check whether the desktop subject program package corresponding to the target desktop subject in the mobile terminal is stored locally or not. If the result of the scanning is yes, the desktop subject program package corresponding to the target desktop subject is obtained from the mobile terminal locally; otherwise, the user is prompted to download the desktop subject program package corresponding to the target desktop subject.

B2. Performing the decompressing process of the desktop subject program package to obtain the executable file (dex file) and the resource file.

B3. Loading the executable file and the resource file of the desktop subject program through the operating system of the mobile terminal to execute the desktop subject program.

In another embodiment of the present disclosure, before B3, the method further includes the following step removing the executable file and the resource file of the desktop subject program corresponding to the current desktop subject from the memory to save the memory resource.

In this embodiment, after determining the target desktop subject from the desktop subject list, the desktop subject program corresponding to the target desktop subject is executed, and the reconfiguration of the interface arrangement and the interface operating manner of the mobile terminal desktop through the desktop subject program is performed, so that the mobile terminal may quickly and conveniently switch to the target desktop subject from the current desktop subject. Because when switching to the target desktop subject from the current desktop subject, both the interface arrangement and the interface operating manner of the mobile terminal desktop may change, so that the diversification and better interaction of the switching form of the desktop subjects are experienced.

In another embodiment of the present disclosure, when the desktop subject list in the mobile terminal is the desktop subject list pulled from a network, before step S103, the method further includes determining whether the desktop subject program corresponding to the target desktop subject has been downloaded and installed in the mobile terminal; if the desktop subject program corresponding to the target desktop subject has not been downloaded, it is downloaded from the network or through another process, and installed into the mobile terminal. If the desktop subject program corresponding to the target desktop subject has not been installed, it is installed into the mobile terminal.

In this embodiment, because the desktop subject list may be pulled from a network directly, and after the desktop list has been pulled, any desktop subject in the desktop subject list may be switched to, it is convenient to dynamically popularize the desktop subjects, and provide richer and more diversified desktop subjects for the mobile terminal.

### Embodiment 2

In this embodiment, the method shown in FIG. 1 may be used by a desktop application program, in which the downloading, updating, loading, or switching process of the desktop subjects of the mobile terminal may be performed through the desktop application program, so that the user may download and install only one desktop application program, and use different desktop subjects in various interface arrangements and interface operating manners.

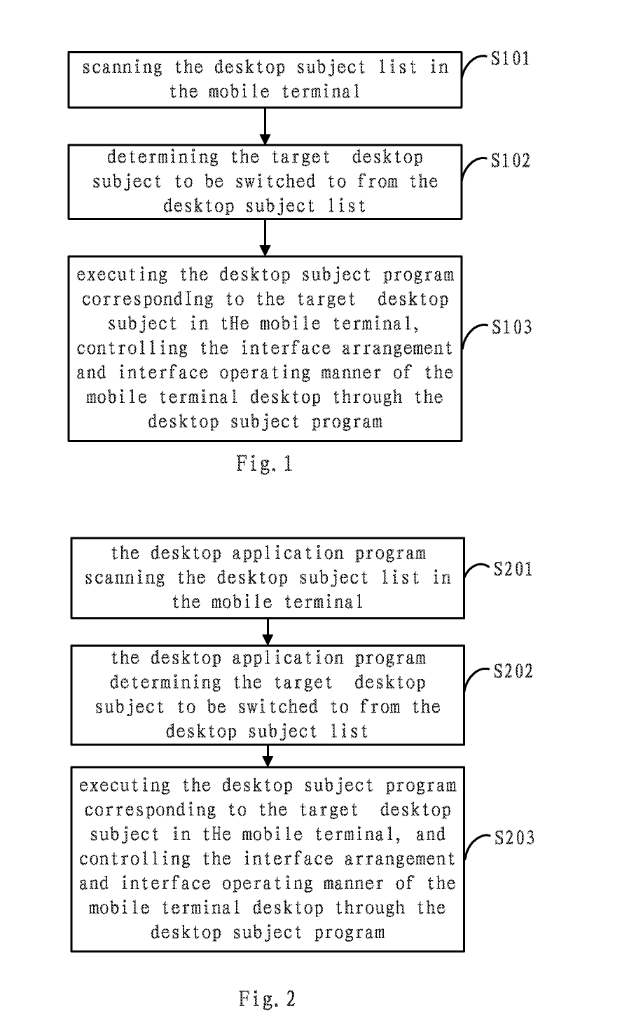

FIG. 2 is a flow diagram showing a method of switching desktop subjects based on the desktop application program according to the embodiment of the present disclosure. Referring to FIG. 2, the detailed description is as follows.

In step S201, the desktop application program scans the desktop subject list in the mobile terminal.

Specifically, the desktop application program scans desktop subject programs that the desktop application program in the mobile terminal supports, and assembles the desktop subjects corresponding to the scanned desktop subject programs as a desktop subject list.

One example of the specific process of “the desktop application program scans desktop subject programs that the desktop application program in the mobile terminal supports” is as follows the desktop application program scans desktop subject programs in the mobile terminal, and determines whether the scanned desktop subject programs are the desktop subject programs developed using the subject Software Development Kit (SDK). If the result of the determination is yes, it is determined that the scanned desktop subject programs are the desktop subject programs supported by the desktop application program.

Specifically, a method of Basic Application Programming Interface (BAPI) of the desktop application program is provided in the subject SDK, so the desktop application program can recognize the desktop subject programs developed using the subject SDK.

In step S202, the desktop application program determines the target desktop subject to be switched to from the desktop subject list. The specific process is described as above, and the repeated description thereof is omitted here.

In step S203, the desktop subject program corresponding to the target desktop subject in the mobile terminal is executed, and the interface arrangement and the interface operating manner of the mobile terminal desktop through the desktop subject program is controlled.

The “executing the desktop subject program corresponding to the target desktop subject in the mobile terminal” may be embodied as follows the desktop application program executes the desktop subject program corresponding to the target desktop subject in the mobile terminal through the “intent” process, this is embodied as follows the desktop application program constructs an “intent” used to execute the desktop subject program corresponding to the target desktop subject, and the operating system of the mobile terminal executes the desktop subject program corresponding to the target desktop subject according to the “intent”.

The manner of “executing the desktop subject program corresponding to the target desktop subject in the mobile terminal” may further be as follows obtaining the desktop subject program package corresponding to the target desktop subject; executing the decompression processing of the desktop subject program package to obtain the executable file (dex file) and the resource file of the desktop subject program; loading the executable file and the resource file of the desktop subject program through the operating system of the mobile terminal to execute the desktop subject program.

In this embodiment, the switching of the desktop subjects through desktop application program is carried out, so that the user of the mobile terminal downloads and installs only the desktop application program to use various desktop subjects, thus enhancing the user's experience.

FIG. 3 shows a construction of the apparatus for switching desktop subjects of a mobile terminal according to the embodiment of the present disclosure. For convenience of illustration, only parts related to the embodiments of the present disclosure are shown.

The apparatus for switching desktop subjects of a mobile terminal may be used in the mobile terminal. It may be a software unit, a hardware unit or a unit combining software and hardware, executing in the mobile terminal, or an independent attached unit integrated into the mobile terminal or executing in the application system of the mobile terminal. The apparatus for switching desktop subjects of mobile terminal comprises a list scanning unit 1, a target subject conforming unit 2, and a subject switching unit 3.

The list scanning unit 1 is configured to scan the desktop subject list in the mobile terminal. Specifically, the list scanning unit 1 is specifically configured to scan the desktop subject programs having been downloaded and installed in the mobile terminal and the desktop subject programs built in the mobile terminal, and assemble the desktop subjects corresponding to the scanned desktop subject programs as a desktop subject list.

In this embodiment, after receiving the desktop subject list displaying instructions, the list scanning unit 1 scans the desktop subject list in the mobile terminal. The manner of entering the desktop subject list displaying instructions does not limit the scope of the present disclosure.

In another embodiment of the present disclosure, the list scanning unit 1 may also pull the desktop subject list through a network.

The target subject conforming unit 2 is configured to determine the target desktop subject to be switched to from the desktop subject list.

The subject switching unit 3 is configured to execute the desktop subject program corresponding to the target desktop subject, and to control the interface arrangement and the interface operating manner of the mobile terminal desktop through the desktop subject program.

In an embodiment of the present disclosure, the subject switching unit 3 comprises a first switching module 31. This is configured to construct the “intent” of the desktop subject program corresponding to the target desktop subject, so that the operating system of the mobile terminal executes the desktop subject program corresponding to the target desktop subject according to the “intent”.

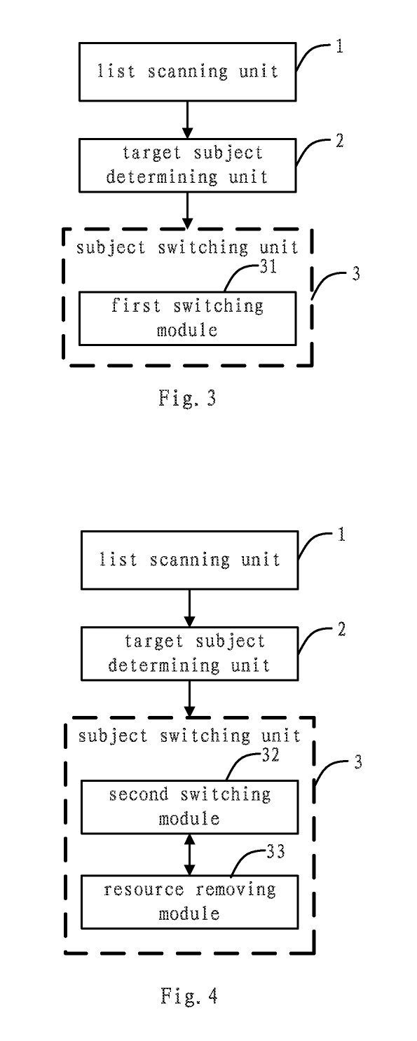

In another embodiment of the present disclosure, referring to FIG. 4, the subject switching unit 3 comprises a second switching module 32. This is configured to obtain the desktop subject program package corresponding to the target desktop subject, to execute the decompression processing of the desktop subject program package to obtain the executable file and the resource file of the desktop subject program, to load the executable file and the resource file of the desktop subject program through the operating system of the mobile terminal to execute the desktop subject program.

Preferably, referring to FIG. 4, the subject switching unit 3 further comprises a resource removing module 33. This is configured to before loading the executable file and the resource file of the desktop subject program corresponding to the target desktop subject, remove the executable file and the resource file of the desktop subject program corresponding to the current desktop subject from the memory.

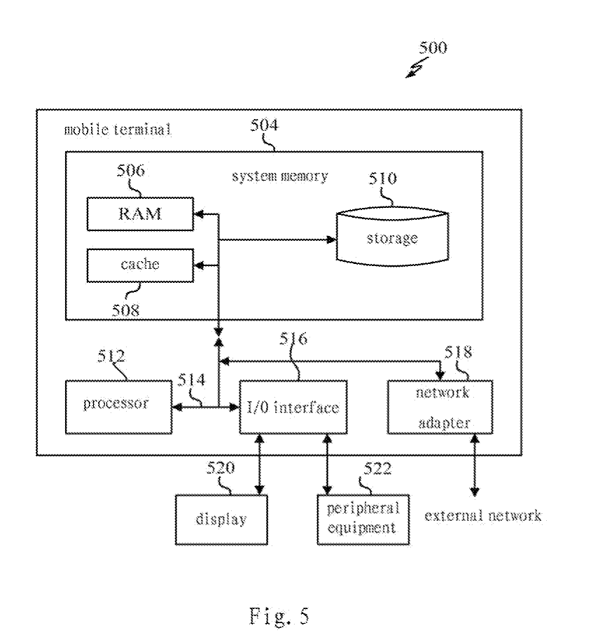

FIG. 5 shows a construction of the mobile terminal of the respective embodiments of the present disclosure.

The mobile terminal 500 shown in FIG. 5 is merely an example, and it does not have any restriction on the function and the usage range of embodiments of the present disclosure. As shown in FIG. 5, the mobile terminal 500 may take the form of a general calculating device. The components of the mobile terminal 500 can include but are not limited to one or more processor(s) or processing unit(s) 512, a system memory 504, an I/O interface 516, a network adapter 518, a display 520, peripheral equipment 522, and the bus 514 coupling different components.

The bus 514 represents one or more of multiple bus architectures. For example, the bus architectures include but are not limited to an Industry Standard Architecture (ISA) bus, a Microchannel Architecture (MAC) bus, an Enhancement Mode ISA bus, a Video Electronic Standard Association (VESA) local bus, a Peripheral Component Interconnection (PCI) bus, and the like.

The mobile terminal 500 typically includes multiple non-transitory computer-readable media. The media may be any readable medium that can be accessed by the mobile terminal 500, including a volatile medium, a non-volatile medium, a removable medium, and a non-removable medium.

The system storage 504 may include a readable medium in the form of a volatile storage medium, for example, a Random Access Memory (RAM) 506 and/or a cache 508. The mobile terminal 500 may further include other removable/non-removable, volatile/non-volatile media. For example, the mobile terminal 500 (usually referred to as “hard disk drive”) may be used to read from or write into a non-removable, non-volatile medium. Although not shown in FIG. 5, it is also possible to provide a magnetic disk drive used to read from or write into a movable, non-volatile magnetic disk (for example, floppy disk), and an optical disk drive used to read from or write into a movable, non-volatile optical disk (for example, CD-ROM, DVD-ROM or other optical medium). In those cases, each drive can be connected to the bus 514 through one or more data medium interface(s).

The system memory 504 may include at least one program product. The program product has a group (at least one) of program modules that can be stored in a storage system 510. The program modules include computer executable program instructions. The program modules are configured to execute the program instructions therein through a processing unit 512 to execute the functions of the respective embodiments of the present disclosure. The program modules include, but are not limited to, an operating system, one or more application program(s), other program modules, and program data. Each or a certain combination of those program modules may include the realization of a network environment.

The mobile terminal 500 may communicate with one or more peripheral equipment(s) 522 (for example, a keyboard, a mouse, and a microphone) and display (or speaker) (s) 520, and the like, and may also communicate with one or more device(s) that can make the user interact with the mobile terminal 500. The communication can be made through an I/O interface 516. Moreover, the terminal device 500 may also communicate with one or more network(s) (for example, a Local Area Network (LAN), a Wide Area Network (WAN) and/or a public network, such as the Internet) through a network adapter 518 (for example, a network card, a modem). As shown in FIG. 5, the I/O interface 516 and the network adapter 518 communicate with the other modules of the mobile terminal 500 through the bus 514. It should be understood that although it is not shown in FIG. 5, the other hardware and/or software modules can be used through the mobile terminal 500, those other hardware and/or software modules can be, but are not limited to, microcodes, a device drive, a redundance processing unit, an external disk drive array, a RAID system, magnetic tape drive, and a data backup storage system, or the like.

All of the respective units and modules of the embodiments of the present disclosure, such as the list scanning unit 1, the target subject conforming unit 2, the subject switching unit 3, first switching module 31, second switching module 32, and resource removing module 33, can be realized by executing the program modules having the computer program instructions in the mobile terminal 500.

It should be noted that the respective units included in the above switching apparatus are just specified according to the function logics, but they are not limited to the above specific process, as long as the corresponding functions can be carried out. In addition, the specific names of the respective units are just to be used for ease of recognition and do not limit the scope of protection of the present disclosure.

It should be understood by those skilled in the art that all or part of the steps in the switching method of the above embodiments and the functions of the respective units and modules in the switching apparatus can be carried out through the program that instructs the corresponding hardware. The corresponding program can be stored into a computer-readable storage medium, for example, the storage medium may be a ROM/RAM, a magnetic disk, or an optical disk, or the like.

In this embodiment, the target desktop subject to be switched to from the desktop subject list in the mobile terminal is determined by scanning it; the desktop subject program corresponding to the target desktop subject in the mobile terminal is executed, and the interface arrangement and the interface operating manner of the mobile terminal desktop is controlled through executing the desktop subject program, so that the diversification and better interaction switching form of the desktop subject can be experienced. Before loading the executable file and the resource file of the desktop subject program corresponding to the target desktop subject, the executable file and the resource file of the desktop subject program corresponding to the desktop subject before the switching are removed from the memory to save the memory resource.

The above descriptions are only the preferred embodiments of the present disclosure, and they should in no way restrict the present disclosure. Any modifications, equivalent substitutions, and improvements within the spirit and principle of the present disclosure should be included in the scope of protection of the present disclosure.

What is claimed is:

1. A method of switching desktop subjects of a mobile terminal, comprising:
scanning, by a list scanning module using a processor, the desktop subject list in the mobile terminal;
determining, by a target subject determining unit using a processor, the target desktop subject to be switched to from the desktop subject list; and
executing, by a subject switching module using a processor, the desktop subject program corresponding to the target desktop subject in the mobile terminal to control the interface arrangement and the interface operating manner of the mobile terminal desktop through the desktop subject program.

2. The method according to claim 1, the step of scanning the desktop subject list in the mobile terminal comprising:
scanning the desktop subject program having been downloaded and installed in the mobile terminal, and assembling the desktop subjects corresponding to the scanned desktop subject programs as a desktop subject list.

3. The method of claim 1, the step of executing the desktop subject program corresponding to the target desktop subject in the mobile terminal comprising:
constructing the “intent” for executing the desktop subject program corresponding to the target desktop subject; and
executing the desktop subject program corresponding to the target desktop subject by the operating system of the mobile terminal according to the “intent”.

4. The method of claim 1, the step of executing the desktop subject program corresponding to the target desktop subject in the mobile terminal comprising:
obtaining a desktop subject program package corresponding to the target desktop subject;
performing the decompression processing of the desktop subject program package to obtain the executable file and the resource file; and
loading the executable file and the resource file of the desktop subject program through the operating system of the mobile terminal to execute the desktop subject program.

5. The method of claim 4,
before loading the executable file and the resource file of the desktop subject program through the operating system of the mobile terminal to execute the desktop subject program, further comprising:
removing the executable file and the resource file of the desktop subject program corresponding to the current desktop subject from the memory.

6. An apparatus for switching desktop subjects of a mobile terminal, comprising:
a list scanning module using a processor and configured to scan the desktop subject list in the mobile terminal;
a target subject determining module using a processor and configured to determine the target desktop subject to be switched to from the desktop subject list; and
a subject switching module using a processor and configured to execute the desktop subject program corresponding to the target desktop subject to control the interface arrangement and the interface operating manner of the mobile terminal desktop through the desktop subject program.

7. The apparatus of claim 6,
the list scanning module is further configured to scan the desktop subject programs having been downloaded and installed in the mobile terminal and the desktop subject programs built in the mobile terminal, and assemble the desktop subjects corresponding to the scanned desktop subject programs as a desktop subject list.

8. The apparatus of claim 6, the subject switching module comprising:
a first switching module using a processor and configured to construct the “intent” of the desktop subject program corresponding to the target desktop subject, so that the operating system of the mobile terminal executes the desktop subject program corresponding to the target desktop subject according to the “intent”.

9. The apparatus of claim 6, the subject switching module comprising:
a second switching module using a processor and configured to obtain the desktop subject program package corresponded by the target desktop subject, execute the decompression processing of the desktop subject program package to obtain the executable file and the resource file of the desktop subject program, load the executable file and the resource file of the desktop subject program through the operating system of the mobile terminal to execute the desktop subject program.

10. The apparatus of claim 6, the subject switching module further comprising:
a resource removing module using a processor and configured to: before loading the executable file and the resource file of the desktop subject program corresponding to target desktop subject, remove the executable file and the resource file of the desktop subject program corresponding to current desktop subject from the memory.

11. A non-transitory computer-readable storage medium storing program instructions, when the program instructions are executed on a computer, the program instructions cause the computer to execute the steps of the method according to claim 1.
